(19) United States
(12) Patent Application Publication
(10) Pub. No.: US 2006/0172160 A1
(43) Pub. Date: Aug. 3, 2006

(54) Fuel cell system

(76) Inventors: Myoung-Ki Min, Suwon-si (KR); Ri-A Ju, Suwon-si (KR); Ho-Jin Kweon, Suwon-si (KR)

Correspondence Address: CHRISTIE, PARKER & HALE, LLP, PO BOX 7068, PASADENA, CA, 91109-7068, US

(21) Appl. No.: 11/346,420

(22) Filed: Feb. 1, 2006

(30) Foreign Application Priority Data
Feb. 2, 2005 (KR) 10-2005-0009426

(51) Int. Cl. H01M 8/04

(52) U.S. Cl. 429/13; 429/23

(57) ABSTRACT

The fuel cell system includes a fuel supply unit for supplying a fuel containing hydrogen, an oxygen supply unit for supplying oxygen, an electricity generation unit for generating electricity through an electro-chemical reaction of the fuel supplied by the fuel supply unit or the hydrogen generated from the fuel, and the oxygen supplied by the oxygen supply unit, and a poison removing unit for removing a catalyst poison comprising carbon monoxide by applying a reverse voltage to the electricity generation unit when a voltage drops below a reference value due to catalyst poisoning of the electricity generation unit by the carbon monoxide.

### CROSS-REFERENCE TO RELATED APPLICATION

This application claims priority to and the benefit of Korean Patent Application No. 10-2005-0009426 filed in the Korean Intellectual Property Office on Feb. 2, 2005, the entire content of which is incorporated herein by reference.

### BACKGROUND OF THE INVENTION

1. Field of the Invention

The present invention relates to a fuel cell system, and more particularly to a fuel cell system capable of removing carbon monoxide, which is a poison to an anode to which a hydrogen gas is supplied, by applying a reverse voltage in an oxidation reaction of the carbon monoxide.

2. Description of the Related Art

In general, a fuel cell system is an electricity generating system which directly converts chemical reaction energy of oxygen and hydrogen contained in a hydrocarbon material such as methanol, ethanol, and a natural gas into an electrical energy. The fuel cell is classified into a high temperature fuel cell and a low temperature fuel cell according to an operating temperature.

As examples of the high temperature fuel cell, there are a molten carbonate fuel cell (MCFC) and a solid oxide fuel cell (SOFC). As examples of the low temperature fuel cell, there are an alkaline fuel cell (AFC), a phosphoric acid fuel cell (PAFC), a polymer electrolyte fuel cell (PEMFC), and a direct liquid fuel cell (DLFC).

All the fuel cells are constructed with substantially the same principle. The fuel cells may be classified into various types according to fuel types, operating temperatures, catalysts, electrolytes, and the like.

The polymer electrolyte membrane fuel cell (PEMFC), which has been recently developed, has an excellent output characteristic, a low operating temperature, and fast starting and response characteristics. In addition, the polymer electrolyte fuel cell advantageously has a wide range of applications including a mobile power source for vehicles, a distributed power source for home or buildings, and a small-sized power source for electronic apparatuses.

In the polymer electrolyte fuel cell, a fuel pump operates to supply a fuel stored in a fuel tank to a reformer, and the reformer reforms the fuel to generate hydrogen. A stack of the polymer electrolyte fuel cell performs electro-chemical reaction of the hydrogen and oxygen to generate electrical energy. In order to supply the oxygen to the stack, a unit for forcibly fanning an air containing the oxygen may be provided.

The reformer is a unit for generating the hydrogen from the fuel containing the hydrogen through a chemical catalytic reaction using thermal energy. Since the reformed gas generated by the reformer contains a small amount of carbon monoxide (CO) as well as the hydrogen, a unit for removing the carbon monoxide is additionally provided.

Since the direct liquid fuel cell (DLFC) directly uses an organic compound liquid fuel such as methanol and ethanol, the direct liquid fuel cell typically does not require peripheral units such as a reformer. The direct liquid fuel cell has advantages in easily storing and supplying the fuel and having high energy and electric power densities. A direct liquid fuel cell using methanol as a fuel is called a direct methanol fuel cell (DMFC).

In the direct liquid fuel cell (DLFC), a fuel pump operates to supply a fuel stored in a fuel tank to a stack, and the stack performs an electro-chemical reaction of an organic compound liquid fuel such as methanol and oxygen as an oxidant to generate electrical energy. In order to supply the oxygen to the stack, a unit for forcibly fanning an air containing the oxygen is provided.

In the fuel cell system such as a polymer electrolyte fuel cell (PEMFC) and a direct liquid fuel cell (DLFC), the stack which substantially generates electricity includes several to ten stacked unit cells. Each unit cell includes a membrane electrode assembly (MEA) and separators attached on both sides of the membrane electrode assembly. The membrane electrode assembly includes an anode, a cathode, and an electrolyte membrane interposed therebetween.

The separators separate the membrane electrode assemblies. In addition, the separators function as paths for supplying the hydrogen and the oxygen required for the reaction in the fuel cell to the anode and the cathode of the membrane electrode assembly, respectively, and as a conductor for directly connecting the anode and the cathode of the membrane electrode assembly. Namely, the hydrogen is supplied to the anode through the separators, and the oxygen is applied to the cathode through the separators. In the meantime, an oxidation reaction of the hydrogen by a catalyst occurs in the anode, and a reduction reaction of the oxygen by a catalyst occurs in the cathode. As a result, generated electrons move to generate electricity, and heat and water are generated.

In a conventional polymer electrolyte fuel cell (PEMFC) where the reformer is provided with a unit for removing the carbon monoxide, it is difficult to completely perform a chemical catalytic reaction for removing the carbon monoxide, so that a reformed gas containing a small amount of the carbon monoxide may be supplied to the membrane electrode assembly.

When the reformed gas containing even a small amount of the carbon monoxide is supplied to the membrane electrode assembly, catalyst activity is weakened because the carbon monoxide is a catalyst poison to the anode. As a result, there are problems of deterioration in performance of the fuel cell and shortening of lifetime of the fuel cell.

On the other hand, in a conventional direct liquid fuel cell (DLFC), the carbon monoxide is generated as a by-product of the oxidation reaction of the liquid fuel in the anode, so that the catalyst poison of the carbon monoxide is generated.

Although the conventional direct liquid fuel cell uses a catalyst alloy of a transition metal such as ruthenium, rhodium, osmium, and nickel in order to prevent catalyst poisoning by the carbon monoxide, the catalyst alloy may not have sufficient resistance to the carbon monoxide. Further, in a case where the amount of the transition metal increases, there is difficulty in production, and the characteristics of the catalyst varies. As a result, it is impossible to completely prevent catalyst poisoning.

### SUMMARY OF THE INVENTION

The present invention provides a fuel cell system capable of removing a catalyst poison by applying a reverse voltage to an anode to oxidize the carbon monoxide so as to improve or maximize catalyst activity.

According to an aspect of the present invention, the fuel cell system includes a fuel supply unit for supplying a fuel containing hydrogen, an oxygen supply unit for supplying oxygen, an electricity generation unit for generating electricity through an electro-chemical reaction of the fuel supplied by the fuel supply unit or the hydrogen generated from the fuel, and the oxygen supplied by the oxygen supply unit, and a poison removing unit for removing a catalyst poison comprising carbon monoxide by applying a reverse voltage to the electricity generation unit when a voltage of the generated electricity drops below a reference value due to catalyst poisoning of the electricity generation unit by carbon monoxide. During the electro-chemical reaction, the fuel may be oxidized and the oxygen may be reduced.

In the above aspect, the fuel cell system may further include a reformer for generating a reformed fuel containing the hydrogen from the fuel supplied by the fuel supply unit and supplying the reformed fuel to the electricity generation unit.

In addition, the poison removing unit may include a voltage sensing unit for sensing the voltage of the electricity generated by the electricity generation unit, a control unit for controlling an application of the reverse voltage to the electricity generation unit when the voltage sensed by the voltage sensing unit drops below the reference value, and an auxiliary power supply unit for applying the reverse voltage to the electricity generation unit according to a control signal from the control unit.

In addition, the control unit may control the auxiliary power supply unit to apply a driving voltage to an external apparatus when the reverse voltage is applied to the electricity generation unit.

In addition, the control unit may control the application of the reverse voltage by setting the time for applying the reverse voltage to a range of from 0.1 second to 10 seconds.

A time for applying the reverse voltage may be set according to a magnitude of the applied voltage and a material of the catalyst. The time for applying the reverse voltage may be set to be as short as possible in order to reduce load to a capacity of the auxiliary power supply unit. By way of example, since the auxiliary power supply unit may apply a power to an external apparatus during the application of the reverse voltage, the capacity of the auxiliary power supply unit should be increased as the time for applying the reverse voltage is lengthened.

According to another aspect of the present invention, a method of removing a catalyst poison including carbon monoxide from an electricity generation unit of a fuel cell system is provided. The method includes detecting a voltage of an electricity generated by the electricity generation unit, comparing the detected voltage against a reference voltage, and applying a reverse voltage to the electricity generation unit if the detected voltage is less than the reference value, so as to remove the catalyst poison from the electricity generation unit.

### BRIEF DESCRIPTION OF THE DRAWINGS

The above and other features and aspects of the present invention will become more apparent by describing in detail exemplary embodiments thereof with reference to the attached drawings in which:

FIG. 1 is a schematic block diagram showing a fuel cell system according to an embodiment of the present invention;

FIG. 2 is a block diagram showing a poison removing unit of the fuel cell system of FIG. 1;

FIG. 3 is a schematic circuit diagram showing the fuel cell system of FIG. 1;

FIG. 4 is a perspective exploded view showing an electricity generation unit of the fuel cell system of FIG. 3;

FIG. 5 is a perspective exploded view showing a construction of a separator of the fuel cell system of FIG. 3;

FIG. 6 is a partial enlarged cross sectional view showing a construction of a membrane electrode assembly of the fuel cell system of FIG. 3;

FIG. 7 is a schematic block diagram showing a fuel cell system according to another embodiment of the present invention;

FIG. 8 is a schematic circuit diagram showing the fuel cell system of FIG. 7;

FIG. 9 is a graph showing cyclic voltammograms (CVs) for a platinum-based catalyst and CO stripping voltammograms;

FIG. 10 is a graph showing a change in voltages with respect to time in the fuel cell system according to an embodiment of the present invention; and

FIG. 11 is a graph showing a change in a current with respect to time in a case where a reverse voltage is applied to an anode according to an embodiment of the present invention.

### DETAILED DESCRIPTION

Now, a fuel cell system according an embodiment of the present invention will be described in detail with reference to the accompanying drawings.

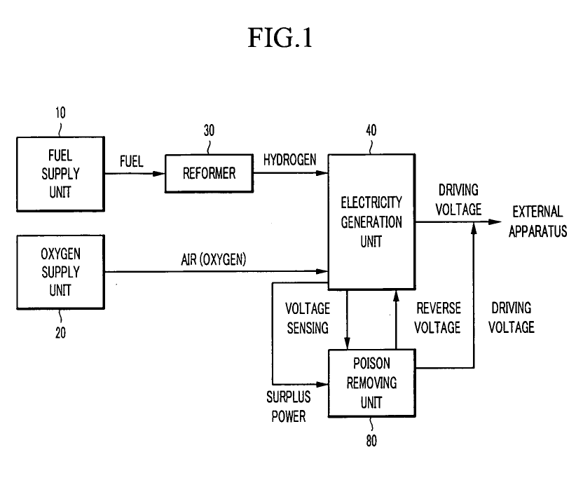

Referring to FIGS. 1 to 3, the fuel cell system according to an embodiment of the present invention includes a fuel supply unit 10 for supplying a fuel containing hydrogen, an oxygen supply unit 20 for supplying oxygen, a reformer 30 for generating the hydrogen from the fuel supplied by the fuel supply unit 10, at least one electricity generation unit 40 for generating electricity through an electro-chemical reaction of the hydrogen supplied by the reformer 30 and the oxygen supplied by the oxygen supply unit 20, and a poison removing unit 80 for removing a catalyst poison by applying a reverse voltage when a voltage drops below a reference value (e.g., a predetermined value) due to the catalyst poisoning of the electricity generation unit 40 by carbon monoxide.

The embodiment of the present invention shown in FIGS. 1 to 3 is a polymer electrolyte membrane fuel cell (PEMFC) which reforms the fuel containing the hydrogen to generate a reformed fuel (e.g., reformed gas) and performs the electro-chemical reaction of the hydrogen and the oxygen to generate electrical energy.

The fuel supplied by the fuel supply unit 10 is a fuel containing hydrogen such as methanol, ethanol, or a natural gas, but is not limited thereto. Hereinafter, the fuel is called a liquid fuel for the convenience of description.

The oxygen supply unit 20 supplies the oxygen which reacts with the hydrogen contained in the fuel. Alternatively, a pure oxygen stored in separate storage unit may be used. Alternatively, an air containing the oxygen, for example, the atmospheric air, may be used. Hereinafter, the embodiment will be described with reference to air as an oxygen source for the convenience of description.

The reformer 30 generates the reformed fuel (e.g., reformed gas) containing the hydrogen from the fuel through a chemical catalytic reaction (e.g., steam reformer (SR) catalytic reaction) using thermal energy and reducing a concentration of carbon monoxide (CO) contained in the reformed fuel by using various reforming structures. For example, the reformer 30 may generate the reformed fuel containing the hydrogen from the fuel through a catalytic reaction such as a steam reforming reaction, a partial oxidation reaction, or an auto-thermal reaction, but is not limited thereto. In addition, the reformer 30 may reduce the concentration of carbon monoxide (CO) contained in the reformed fuel by using a catalytic reaction such as, but is not limited to, a water-gas shift (WGS) reaction and a preferential CO oxidation (PROX) reaction or a hydrogen purification reaction using a separating membrane.

The fuel supply unit 10 includes a fuel tank 12 for storing the fuel containing the hydrogen and a fuel pump 14 connected to the fuel tank 12 to supply the fuel stored in the fuel tank 12 to the reformer 30.

The fuel tank 12 and the reformer 30 are coupled to each other through a fuel supply line 15 having a shape of pipe.

The oxygen supply unit 20 includes a fanning unit 22 for sucking the air with a pumping force, which may have been predetermined, and supplying the air to the electricity generation unit 40.

In one embodiment, a fan mounted on an external apparatus connected to the fuel cell system such as a portable electronic apparatus, for example, a notebook PC, may be used as the fanning unit 22. The fanning unit 22 is not limited to such a fan, but a conventional air pump or fan or any other suitable air supply device may be used.

The fanning unit 22 and the electricity generation unit 40 are coupled to each other through an air supply line 25. A flow rate regulating valve 24 for regulating a flow rate of the supplied air may be provided to the air supply line 25.

The flow rate regulating valve 24, for example, may include a general solenoid valve which can selectively open and close a path of the air supply line 25 according to a control signal applied by a separate control device.

The electricity generation unit 40 is connected to an external apparatus such as, for example, a driving unit of an electric car or a hybrid car, a notebook computer, a mobile phone, PDA, or a camcorder to apply a driving voltage thereto.

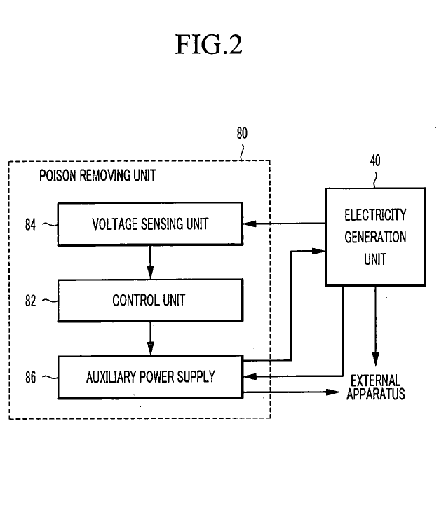

As shown in FIG. 2, the poison removing unit 80 includes a voltage sensing unit 84 for sensing a voltage generated by the electricity generation unit 40; a control unit 82 for controlling the application of the reverse voltage to the electricity generation unit 40 when the voltage sensed by the voltage sensing unit 84 drops below a reference value (e.g., predetermined value); and an auxiliary power supply unlit 86 for applying the reverse voltage to the electricity generation unit 40 according to a control signal of the control unit 82. To determine whether to apply the reverse voltage, the voltage sensing unit 84 or the control unit 82 may compare the sensed voltage against the reference value.

The auxiliary power supply unit 86 may include a primary or rechargeable battery (or secondary battery) separately provided. Alternatively, the auxiliary power supply unit 86 may include a capacitor or super-capacitor connected to the electricity generation unit 40 and charged with a surplus power of the electricity generation unit 40.

In addition to the function of applying the reverse voltage to the electricity generation unit 40, the auxiliary power supply unit 86 has a function of supplying a driving voltage to the external apparatus in a state where the electricity generation unit 40 does not generate electricity.

The control unit 82 controls the auxiliary power supply unit 86 to apply the reverse voltage to the electricity generation unit 40 when the voltage generated by the electricity generation unit 40 drops below 80% of a normal driving voltage for the external apparatus.

The application of the reverse voltage from the auxiliary power supply unit 86 to the electricity generation unit 40 is achieved by connecting plus (+) and minus (−) electrodes of the auxiliary power supply unit 86 to the cathode and anode of the electricity generation unit 40, respectively.

The application of the reverse voltage from the auxiliary power supply unit 86 to the electricity generation unit 40 may be controlled by using various electric and/or electronic switches as those skilled in the art would appreciate.

The control unit 82 in the described embodiment controls a time (e.g., duration or period) for applying the reverse voltage from the auxiliary power supply unit 86 to the electricity generation unit 40 to be as short as possible. The control unit in other embodiments may control the time for applying the reverse voltage in other suitable manners.

If the time for applying the reverse voltage is too long, since the volume of the auxiliary power supply unit 86 increase in proportion to the time, the size of the associated apparatus increases. In addition, the time for applying the reverse voltage should be set to a time suitable to remove the catalyst poison. Since the function of removing the catalyst poison is not performed by applying the reverse voltage for a time exceeding the suitable time, it is typically unnecessary to apply the reverse voltage for a time exceeding the suitable time to remove the catalyst poison.

The control unit 82 controls the application of the reverse voltage by setting the time for applying the reverse voltage from the auxiliary power supply unit 86 to the electricity generation unit 40 to a range of from 0.1 second to 10 seconds. The time for applying the reverse voltage controlled by the control unit 82 may be set according to a magnitude of the reverse voltage and a size of the electrode from which poison is to be removed. In the described embodiment, the time for applying the reverse voltage should be set to be less than about five seconds.

In the described embodiment, the voltage sensing unit is separately provided, and the poison removing unit is constructed to apply the reverse voltage to the electricity generation unit according to a voltage sensed by the voltage sensing unit. However, the poison removing unit according to the present invention is not limited to the aforementioned construction. For example, the poison removing unit may be constructed to automatically apply the reverse voltage to the electricity generation unit for a period of time (e.g., predetermined period) to remove the catalyst poison formed in the electricity generation unit.

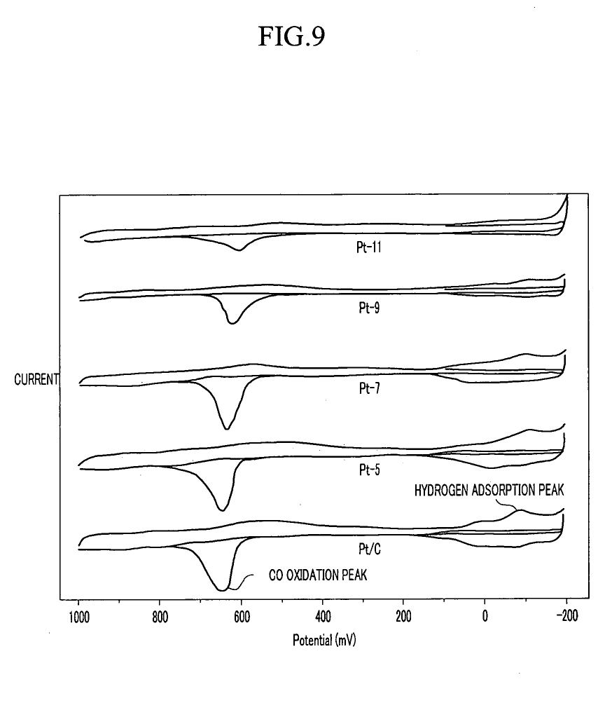

FIG. 9 is a graph showing cyclic voltammograms (CVs) for a platinum (Pt)-based catalyst and carbon monoxide (CO) stripping voltammograms. After the carbon monoxide (CO) is forcibly adsorbed by the platinum catalyst, the oxidation reaction of the carbon monoxide (CO) is scanned with a speed of 20 mV/s while a potential changes from −200 mV to 1,000 mV.

As shown in the graph of FIG. 9, when the carbon monoxide (CO) is adsorbed, all the hydrogen adsorption peaks disappear, and when the carbon monoxide (CO) is oxidized, the hydrogen adsorption peaks appear again. The oxidation reaction of the carbon monoxide (CO) is completed in a time of about five seconds or less in a potential range of from 600 mV to 700 mV. The oxidation reaction of the carbon monoxide (CO) is completed to remove the catalyst poison in a short time of one second or less when the oxidation reaction of the carbon monoxide (CO) is performed at a higher potential of 1 V.

In addition, while the reverse voltage is applied to the electricity generation unit 40, the control unit 82 controls the auxiliary power supply unit 86 to apply a driving voltage to the external apparatus.

In addition to the auxiliary power supply unit 86, a power supply unit for temporarily applying the driving voltage to the external apparatus may be separately provided.

In cases where the time for applying the reverse voltage is set to a short time of five seconds or less, the driving voltage may be applied by using the auxiliary power supply unit 86. However, in cases where the time for applying the reverse voltage and the driving voltage are set to a long time and a high voltage, respectively, since it is difficult to obtain a sufficient capacity by using the auxiliary power supply unit 86, which may be constructed using a capacitor or capacitors only, a separate power supply unit such as primary and/or rechargeable batteries may be provided.

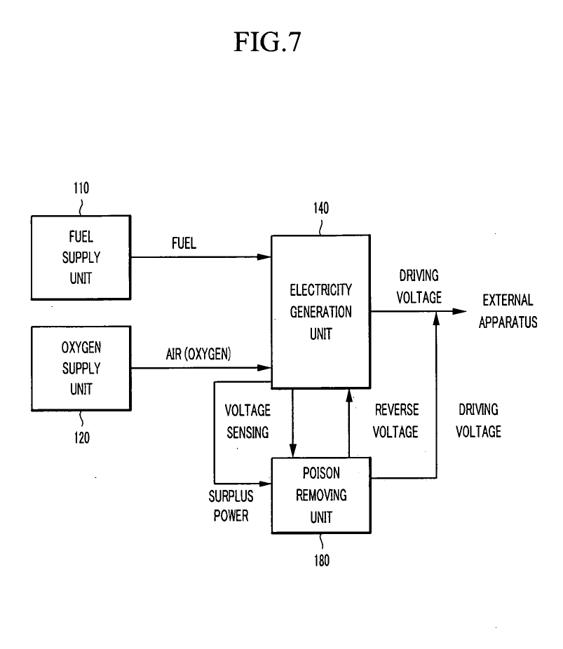

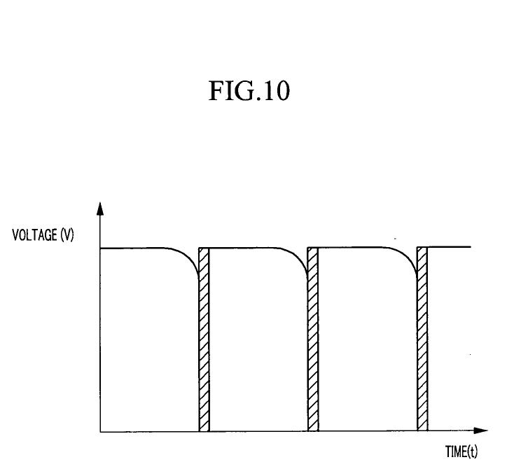

FIG. 10 is a graph showing a change in driving voltages applied by the electricity generation unit 40 and the auxiliary power supply unit 86 with respect to time in the fuel cell system of FIG. 1 or 7, and will be described in reference to the fuel cell system of FIG. 1. More specifically, when the driving voltage generated by the electricity generation unit 40 drops below a reference value (e.g., predetermined value), the auxiliary power supply unit 86 applies the reverse voltage, and the driving voltage is applied to the external apparatus. When the catalyst poison is removed, the electricity generation unit 40 applies the normal driving voltage again.

In FIG. 10, hatching portions denote time intervals for applying the driving voltage by the auxiliary power supply unit 86.

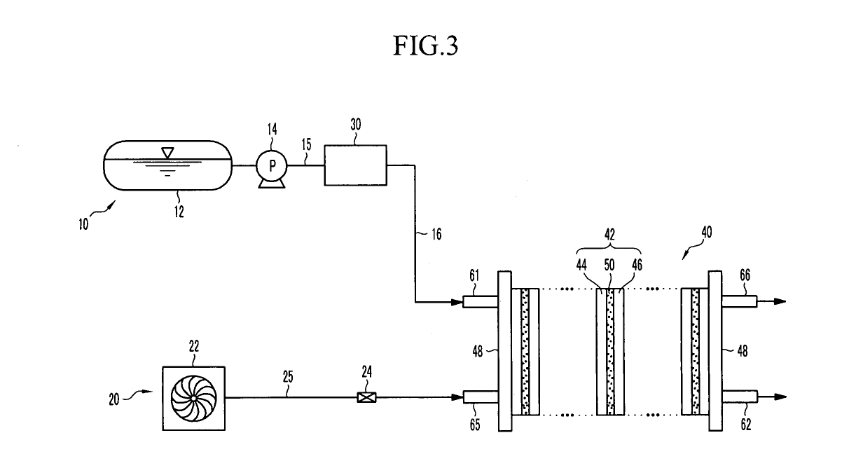

As shown in FIGS. 3 to 6, the electricity generation unit 40 includes membrane electrode assemblies 50, each of which has an anode 56, a cathode 52, and an electrolyte membrane 51 interposed therebetween and separators 44 and 46 which are disposed on respective sides of each membrane electrode assembly 50.

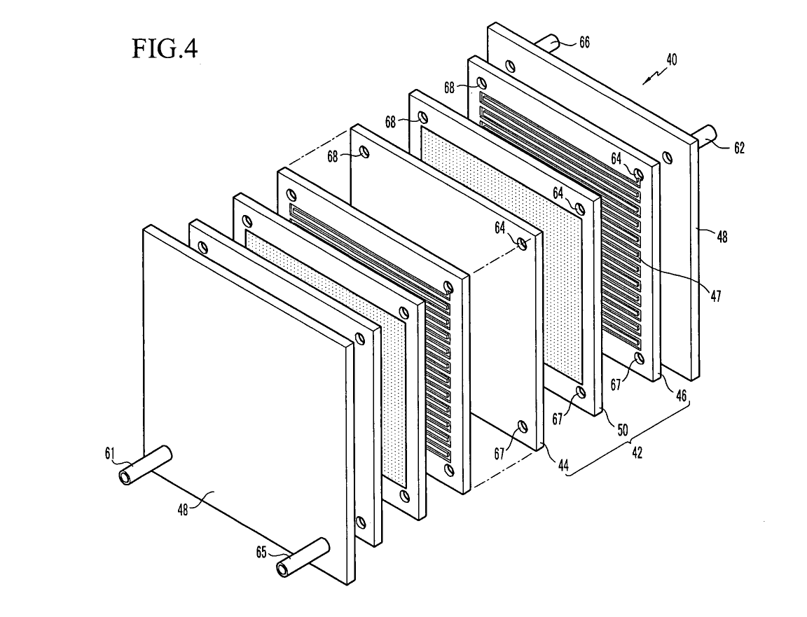

One membrane electrode assembly 50 and a pair of the separators 44 and 46 disposed on respective sides thereof constitute one stack 42 in the described embodiment. The electricity generation unit 40 is constructed with a stacked structure of a plurality of the stacks 42 (see FIGS. 3 and 4).

The stack 42 generates electrical energy through oxidation and reduction reactions of the hydrogen supplied from the reformer 30 and the air supplied by the oxygen supply unit 20.

The outmost ones of a plurality of the stacks 42 may include or be adjacent to attaching plates 48 for attaching (or assembling) the stacks 42 together.

However, the present invention is not limited to embodiments using the attaching plates 48. The attaching plates 48 may be eliminated, and the separators 44 and 46 disposed on the outmost ones of a plurality of the stacks 42 may have a function of attaching the stacks 42 together instead of the attaching plates 48. In other embodiments, in addition to the function of attaching the stacks 42, the attaching plates 48 may have the function of the separators 44 and 46. In those cases, the outermost separators 44 and 46 may be unnecessary.

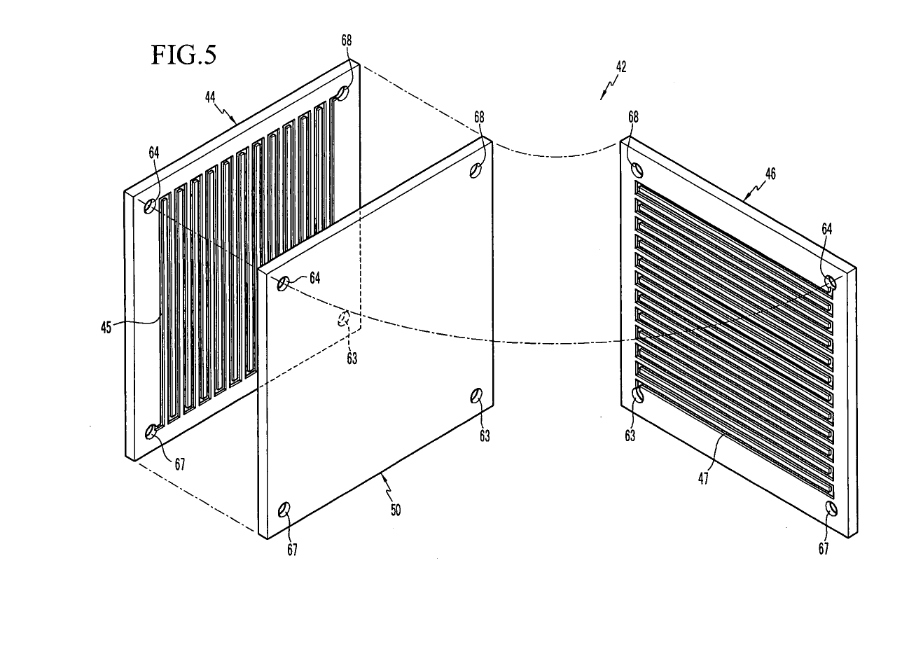

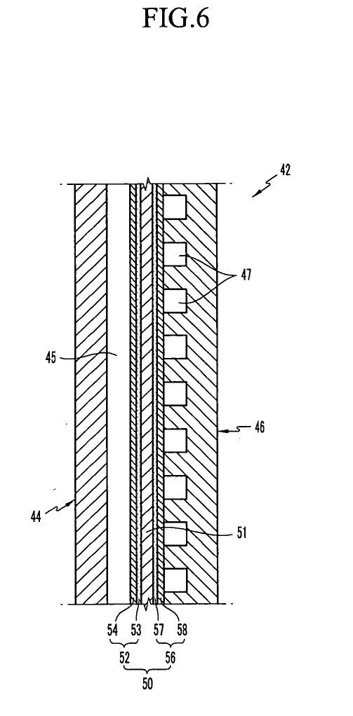

FIG. 5 is a perspective exploded view showing a rotated state of the separator 44 of the separators shown in FIG. 4. FIG. 6 is a partial enlarged cross sectional view showing an assembled state of the membrane electrode assembly 50 and the separators 44 and 46 shown in FIG. 4.

Paths 45 and 47 are formed by attaching the separators 44 and 46 on the membrane electrode assembly 50. The paths 45 and 47 include a hydrogen path 47 formed on the anode side of the membrane electrode assembly 50 and an oxygen path 45 formed on the cathode side of the membrane electrode assembly 50.

In the aforementioned embodiment, two separators 44 and 46 are disposed between the membrane electrode assemblies 50 of the adjacent stacks 42, and the air path 45 or the hydrogen path 47 are formed on the separators 44 and 46. However, the present invention is not limited to this construction. By way of example, one separator may be disposed between the membrane electrode assemblies 50 of the adjacent stacks 42, and an air path and a hydrogen path may be formed on one side and the opposite side of the separator, respectively. This construction is equivalent to a construction where sides of two separators 44 and 46 on which the paths 45 and 47 are not formed are attached.

The anode 56 is supplied with the hydrogen through the hydrogen path 47 of the separator 46. The anode 56 includes a catalyst layer 57 for performing an oxidation reaction of the hydrogen to decompose the hydrogen into electrons and hydrogen ions and a gas diffusion layer (GDL) 58 for smoothly moving the hydrogen into the catalyst layer 57. The catalyst layer 57 of the anode 56 is made of platinum (Pt) or a platinum-ruthenium (Pt-Ru) alloy having poison resistance to the carbon monoxide.

In a case where the catalyst layer 57 is made of platinum (Pt) or a platinum-ruthenium (Pt-Ru) alloy, the catalyst layer 57 has a unique characteristic of reducing a concentration of carbon monoxide through an oxygen adsorption function of inducing the oxidation reaction of the carbon monoxide.

The cathode 52 is supplied with the air through the air path 45 of the separator 44. The cathode 52 includes a catalyst layer 53 for performing a reduction reaction of the oxygen contained in the air to decompose the oxygen into electrons and oxygen ions and a gas diffusion layer 54 for smoothly moving the oxygen into the catalyst layer 53.

The electrolyte membrane 51 is made of a solid polymer electrolyte having a thickness of 50 μn to 200 μm. The electrolyte membrane 51 has a function of moving the hydrogen ions generated in the catalyst layer 57 of the anode 56 to the catalyst layer 53 of the cathode 52 and an ion exchange function of recombining the hydrogen ions with the oxygen ions of the cathode 52 to form water.

As shown in FIGS. 3 and 4, the attaching plates 48 are provided with a first inlet 61 for supplying the hydrogen generated from the reformer 30 to the hydrogen path 47 of the separator 46, a second inlet 65 for supplying the air supplied by the oxygen supply unit 20 to the air path 45 of the separator 44, a first outlet 62 for venting non-reacted hydrogen from the anode 56 of the membrane electrode assembly 50, and a second outlet 66 for venting non-reacted air containing moisture generated by the recombining reaction of the hydrogen and the oxygen in the cathode 52 of the membrane electrode assembly 50.

The first inlet 61 is coupled to the reformer 30 through the hydrogen supply line 16 having a shape of pipe, and the second inlet 65 is coupled to the oxygen supply unit 20 through the air supply line 25.

The first inlet and outlet 61 and 62 are disposed at the diagonal corners, and the second inlet and outlet 65 and 66 are disposed at the diagonal corners.

Though-holes 63, 67, 64, and 68 are formed at the four corners of the separators 44 and 46 and the membrane electrode assemblies 50 to be connected to the first inlet 61, the second inlet 65, the first outlet 62, and the second outlet 66, respectively.

The through-hole 63 and the through-hole 64 are disposed at the diagonal corners of the separator 46 to be connected to the hydrogen path 47, and the through-hole 67 and the through-hole 68 are disposed at the diagonal corners of the separator 44 to be connected to the air path 45. In addition, the through-hole 63 and the through-hole 64 are constructed so as to be disconnected from the air path 45 of the separator 44, and the through-hole 67 and the through-hole 68 are constructed so as to be disconnected from the hydrogen path 47 of the separator 46.

According to the aforementioned construction, the fuel supplied by the fuel supply unit 10 passes through the reformer 30 to be reformed into the hydrogen, and the hydrogen generated from the reformer 30 flows through the hydrogen supply line 16 into the first inlet 61. Subsequently, the hydrogen passes through the through-hole 63 and the hydrogen path 47 to be oxidized in the anode 56 to be decomposed into electrons and hydrogen ions, and non-reacted hydrogen passes through the through-hole 64 to be vented out through the first outlet 62.

In addition, the air supplied by the air supply unit 20 passes through the air supply line 25 to flow into the second inlet 65. Subsequently, while the air passes through the through-hole 67 and the air path 45, the oxygen contained in the air is subject to the reduction reaction in the cathode 52 to be decomposed into electrons and oxygen ions, and non-reacted air passes through the through-hole 68 to be vented out through the second outlet 66.

As a by-product of the reforming process in the reformer 30, a small amount of carbon monoxide is contained in the reformed gas generated by the reformer 30. In a case where the hydrogen is supplied to the anode 56 of the membrane electrode assembly 50, the catalyst layer 57 of the anode 56 is poisoned by the carbon monoxide, so that catalyst activity is weakened. As a result, performance of the electricity generation unit 40 degrades or deteriorates, and the lifetime thereof is shortened.

In this manner, as the catalyst layer 57 of the anode 56 is poisoned, the catalyst activity is weakened. When the control unit 82 determines that the voltage sensed by the voltage sensing unit 84 drops below 80% or less of the driving voltage, the control unit 82 controls the auxiliary power supply unit 86 to apply the reverse voltage and the driving voltage to the anode 56 of the electricity generation unit 40 and the external apparatus, respectively.

When the reverse voltage is applied to the anode 56, the carbon monoxide (CO) is oxidized to form carbon dioxide (CO₂), so that the carbon monoxide (CO) can be easily removed (or removed easier) from the catalyst layer 57. The carbon dioxide may then be removed from the fuel cell through the first outlet 62.

In general, it is known that the poisoning phenomenon of the platinum catalyst by the carbon monoxide (CO) is caused by adsorption of the carbon monoxide (CO) on the surface of the platinum having a particular molecular structure, and thus, by preventing the hydrogen in the gas of the anode side from approaching catalytic activation positions of the platinum. In addition, it is known that the carbon monoxide (CO) adsorbed in the platinum is oxidized to form the carbon dioxide (CO₂), so that the carbon monoxide (CO) can be easily removed (or removed easier) from the platinum.

By taking into consideration the principle, the reverse voltage is applied to the poisoned anode 56 to remove the adsorbed carbon monoxide (CO).

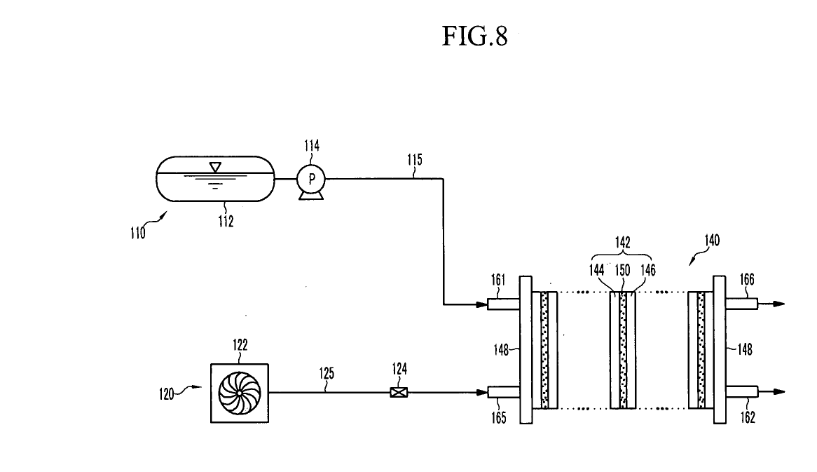

Now, a fuel cell system according to another embodiment of the present invention will be described with reference to FIGS. 7 and 8. The fuel cell system includes a fuel supply unit 110 for supplying a fuel containing hydrogen, an oxygen supply unit 120 for supplying oxygen, at least one electricity generation unit 140 for generating electricity through an electro-chemical reaction of the fuel supplied by the fuel supply unit 110 and the oxygen supplied by the oxygen supply unit 120, and a poison removing unit 180 for removing a catalyst poison by applying a reverse voltage when a voltage drops below a reference value (e.g., predetermined value) due to the catalyst poisoning of the electricity generation unit 140 by carbon monoxide.

The embodiment of the present invention shown in FIGS. 7 and 8 is a direct liquid fuel cell (DLFC) or a direct methanol fuel cell (DMFC) which performs an electro-chemcial reaction of an organic compound fuel such as methanol and ethanol and oxygen as an oxidant to generate electrical energy.

As shown in FIG. 8, a fuel supply unit 110 includes a fuel tank 112 for storing fuel (e.g., methanol or ethanol) and a fuel pump 114 coupled to the fuel tank 112 to supply the fuel to the electricity generation unit 140 through a fuel supply line 115 and a first inlet 161 on a first attachment plate 148 of the electricity generation unit 140. An oxygen supply unit 120 includes a fanning unit 122 for sucking the air with a pumping force and supplying the air to the electricity generation unit 140 through an air supply line 125, a flow rate regulating valve 124 and a second inlet 165 on the first attachment plate 148. The electricity generation unit 140 also includes stacks 142, each including a membrane electrode assembly 150 and separators 144, 146, and a second end plate 148 on which first and second outlets 162, 166 are formed.

Excluding the reformer 30, the embodiment of FIGS. 7 and 8 is similar to the above-described embodiment of FIGS. 1-6. By way of example, the construction and operation of the poison removing unit 180 is substantially the same as that of the poison removing unit 80 of the above-described embodiment, and thus, detailed description thereof is omitted. Further, the electricity generation unit 140 has a structure and operation that is similar to those of the electricity generation unit 40 of FIGS. 1-6, and a detailed description thereof is omitted.

For the fuel cell system of FIGS. 7 and 8, components of the above-described embodiment of FIGS. 1-6 not suitable for the direct liquid fuel cell (DLFC) may be replaced with general components of the direct liquid fuel cell (DLFC) or the direct methanol fuel cell (DMFC) as those skilled in the art would appreciate.

In the embodiment of FIGS. 7 and 8, as a by-product of the oxidation reaction of the fuel, a small amount of carbon monoxide is also generated. When the catalyst poison is generated due to the carbon monoxide, a control unit of the poison removing unit 180, which is substantially the same as the control unit 82 of FIG. 2, controls the auxiliary power supply unit of the poison removing unit 180, which is substantially the same as the auxiliary power supply unit 86 of FIG. 2, to apply the reverse voltage to the anode 56 to remove the catalyst poison by oxidizing the poisoning carbon monoxide to form carbon dioxide. As discussed above, the structure and operation of the poison removing unit 180 is substantially the same as that of the poison removing unit 80 of FIGS. 1 and 2.

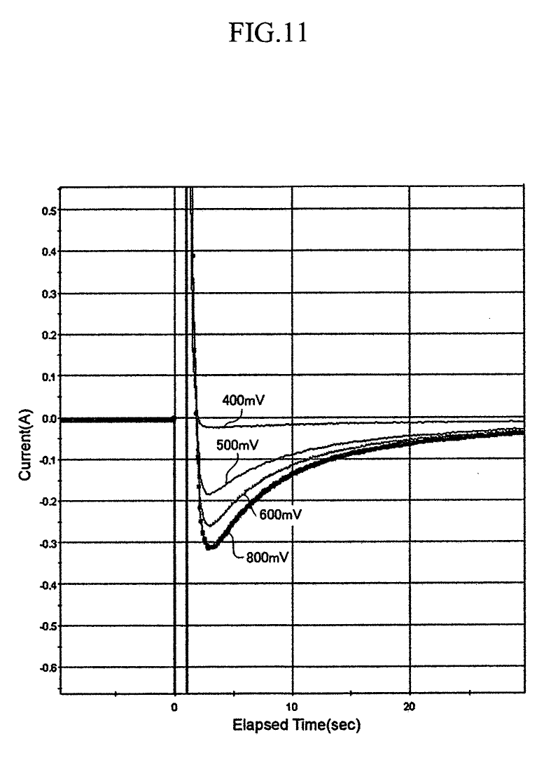

FIG. 11 is a graph showing a result of a test of detecting carbon monoxide which is oxidized and removed from the anode of the membrane electrode assembly by applying the reverse voltage to the anode.

In the test, an arbitrary voltage is applied to the anode, and then, a change in a current with respect to time is measured.

First, while an arbitrary voltage of, for example, 100 mV is applied to the anode, the carbon monoxide is adsorbed on a surface of the platinum (Pt) layer, which is a catalyst layer of the anode. In this case, it can be seen that the value of current is maintained at 0 A.

At this time, when various reverse voltages are applied to the anode, the current value changes according to the applied reverse voltages. In addition, the current has a peak value corresponding to the each of the reverse voltages.

In the test, the reverse voltages of 800 mV, 600 mV, 500 mV, and 400 mV are applied, and a time interval of applying each of the reverse voltages is 1 sec. In FIG. 11, current waveforms after the elapsed time interval of 1 sec are shown. The lowest current waveform corresponds to the reverse voltage of 800 mV. The higher current waveforms sequentially correspond to the smaller reverse voltages. The highest current waveform corresponds to the reverse voltage of 400 mV.

In comparison to the case where a constant voltage is applied, the current values of the current waveforms further drop when the reverse voltages are applied. It is understood that, when the reverse voltage is instantaneously applied to the anode, the carbon monoxide is removed from the surface of the platinum layer of the anode.

According to a fuel cell system in described embodiments of the present invention, when carbon monoxide, which is a catalyst poison to an anode of an electricity generation unit, is generated, an auxiliary power supply unit applies a reverse voltage to oxidize the carbon monoxide to form carbon dioxide, so that the poisoning carbon monoxide can be easily removed (or removed easier). As a result, it is possible to improve or maximize catalyst activity of a catalyst layer, increase the performance of a fuel cell, and lengthen lifetime of the fuel cell.

Although the exemplary embodiments and the modified examples of a fuel cell system according to the present invention have been described herein, the present invention is not limited to the embodiments and examples, but may be modified in various forms without departing from the scope of the appended claims, the detailed description, and the accompanying drawings of the present invention. Therefore, it is natural that such modifications belong to the scope of the present invention.

What is claimed is:

1. A fuel cell system comprising:
a fuel supply unit for supplying a fuel containing hydrogen;
an oxygen supply unit for supplying oxygen;
an electricity generation unit for generating electricity through an electro-chemical reaction of the fuel supplied by the fuel supply unit or the hydrogen generated from the fuel, and the oxygen supplied by the oxygen supply unit; and
a poison removing unit for removing a catalyst poison comprising carbon monoxide by applying a reverse voltage to the electricity generation unit when a voltage of the generated electricity drops below a reference value due to catalyst poisoning of the electricity generation unit by the carbon monoxide.

2. The fuel cell system of claim 1, further comprising a reformer for generating a reformed fuel containing the hydrogen from the fuel supplied by the fuel supply unit and supplying the reformed fuel to the electricity generation unit.

3. The fuel cell system of claim 1, wherein the poison removing unit comprises:
a voltage sensing unit for sensing the voltage of the electricity generated by the electricity generation unit;
a control unit for controlling an application of the reverse voltage to the electricity generation unit when the voltage sensed by the voltage sensing unit drops below the reference value; and
an auxiliary power supply unit for applying the reverse voltage to the electricity generation unit according to a control signal from the control unit.

4. The fuel cell system of claim 3, wherein the control unit controls the auxiliary power supply unit to apply a driving voltage to an external apparatus when the reverse voltage is applied to the electricity generation unit.

5. The fuel cell system of claim 3, wherein the control unit controls the application of the reverse voltage by setting the time for applying the reverse voltage to a range of from 0.1 second to 10 seconds.

6. The fuel cell system of claim 3, wherein the auxiliary power supply unit comprises at least one of a primary battery, a rechargeable battery, or a capacitor connected to the electricity generation unit, the capacitor being adapted to be charged with a surplus power from the electricity generation unit.

7. The fuel cell system of claim 3, wherein the control unit controls the auxiliary power supply unit to apply the reverse voltage to the electricity generation unit when the voltage of the electricity generated by the electricity generation unit drops below 80% of a normal driving voltage.

8. The fuel cell system of claim 1, wherein the fuel supply unit comprises a fuel tank for storing the fuel containing the hydrogen and a fuel pump coupled to the fuel tank to supply the fuel stored in the fuel tank.

9. The fuel cell system of claim 1, wherein the oxygen supply unit includes a fanning unit for supplying the air to the electricity generation unit.

10. The fuel cell system of claim 1, wherein the electricity generation unit comprises a membrane electrode assembly having an anode, a cathode, and an electrolyte membrane interposed therebetween, and separators disposed on respective sides of the membrane electrode assembly and having pass through paths for hydrogen and air.

11. The fuel cell system of claim 10,
wherein the anode comprises a catalyst layer for performing an oxidation reaction of the fuel or the hydrogen and a gas diffusion layer for smoothly moving the hydrogen to the catalyst layer, and
wherein the catalyst layer comprises platinum or a platinum-ruthenium alloy.

12. The fuel cell system of claim 1, wherein the carbon monoxide is oxidized to form carbon dioxide when the reverse voltage is applied, such that an amount of the carbon monoxide in the electricity generation unit is reduced.

13. A method of removing a catalyst poison comprising carbon monoxide from an electricity generation unit of a fuel cell system, the method comprising:
detecting a voltage of an electricity generated by the electricity generation unit;
comparing the detected voltage against a reference voltage; and
applying a reverse voltage to the electricity generation unit if the detected voltage is less than the reference value, so as to remove the catalyst poison from the electricity generation unit.

14. The method of claim 13, wherein said applying the reverse voltage comprises controlling a time for applying the reverse voltage to the electricity generation unit.

15. The method of claim 14, wherein said controlling the time comprises controlling the time for applying the reverse voltage to be between 0.1 second and 10 seconds.

16. The method of claim 13, wherein the reference voltage is 80% of a normal driving voltage of an external apparatus receiving the electricity from the electricity generation unit.

17. The method of claim 13, wherein the catalyst poison is removed through oxidizing the carbon monoxide to form carbon dioxide when the reverse voltage is applied to the electricity generation unit.

18. The method of claim 17, further comprising venting the carbon dioxide through an outlet of the electricity generation unit.
